(19) United States
(12) Patent Application Publication
(10) Pub. No.: US 2004/0230443 A1
(43) Pub. Date: Nov. 18, 2004

(54) System and method of creating, aggregating, and transferring environmental emisssion reductions

(76) Inventors: John A. McMorris III, Indialantic, FL (US); George D. Bolton, Melbourne Beach, FL (US); Alan R. Tank, Bethesda, MD (US); Everett E. (Tracy) Howard, Fellsmere, FL (US); Lewis C. Smyronios, Satellite Beach, FL (US)

Correspondence Address: CARL M. NAPOLITANO, PH.D., ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 10/720,797

(22) Filed: Nov. 24, 2003

Related U.S. Application Data
(60) Provisional application No. 60/429,267, filed on Nov. 26, 2002.
(60) Provisional application No. 60/440,069, filed on Jan. 13, 2003.
(60) Provisional application No. 60/513,498, filed on Oct. 22, 2003.
(60) Provisional application No. 60/498,992, filed on Aug. 29, 2003.

(51) Int. Cl. G06F 17/60

(52) U.S. Cl. 705/1

(57) ABSTRACT

An integrated, holistic methodology for enabling a systematic creation, aggregation, verification, registration, storage, transfer/sale, and retirement of environmental emission removal units provides a control and management system complementing the use of sound foundational science to qualify and quantify environmental emission reductions and removals, and provides the framework for accurate data collection, storage, and processing.

### CROSS-REFERENCE TO RELATED APPLICATIONS

This U.S. Application claims priority to U.S. Provisional Patent Applications having Ser. No. 60/429,267 filed Nov. 26, 2002 for “Environmental Emissions Management System and Method,” Ser. No. 60/440,069 filed Jan. 13, 2003 for “Environmental Emissions Management System and Method,” Ser. No. 60/513,498 filed Oct. 22, 2003 for “System and Method of Creating, Aggregating, and Transferring Agriculturally-Sourced Environmental Emission Reduction Credits,” Ser. No. 60/498,992, filed Aug. 29, 2003 for “System and Method for Creating Emission Reduction Credit Serial Numbers and Enabling Data Transparency” and U.S. Utility Patent Application filed of even date, Nov. 24, 2003 Serial Number to be determined for “System and Method for Tracking Environmental Emission Reductions” the disclosures of which are hereby incorporated herein in their entireties by reference.

### FIELD OF THE INVENTION

The present invention relates to environmental emissions, and in particular to the creation, aggregation, transfer, and accounting thereof.

### BACKGROUND OF THE INVENTION

Environmental emissions are the subject of increasing scrutiny in many industries and municipalities, and are becoming regulated at both the regional and national level. To an increasing extent, business site permits are being used to augment regional policies by requiring pollutant mitigation for air, water, and/or soil.

Policy makers face a seemingly insurmountable dilemma: continuing economic growth/recovery requires expanded energy production and economic output, which leads directly to increased environmental emissions levels—but environmentalists are clamoring for definitive actions to reduce environmental emissions and for a greener environment. This is especially true in the area of Climate Change, wherein environmentalists are seeking wide-ranging reductions in the emissions of greenhouse gases (GHG).

The problem is acute; solutions that mandate energy caps will lead to a head-on collision with industry and may have grave economic consequences; but global emission problems are big. In the GHG area, for instance, existing legislation/accords contemplate worldwide reductions of roughly 2 billion tons (of CO₂ equivalent) annually; furthermore, to stabilize the atmosphere at scientifically recommended CO₂ levels will require worldwide reductions exceeding 10 billion tons per year.

In general, environmental emission reductions can be achieved through abatement techniques (such as installing smokestack scrubbers or by making widespread capital upgrades), by enhancing or eliminating industrial operations that generate significant environmental emissions (future technology is likely to manifest more efficient operations), or by a variety of removal techniques that “scrub” pollutants from the biosphere. Techniques that avoid the production of environmental emissions or that actively reduce existing pollution levels (either technique must be measurable and verifiable and compared to an established baseline) can be used to create environmental emission removal units.

Industry needs an effective, inexpensive, and reliable means to offset environmental emissions for the next 30 years or more, until emerging processes and new capital equipment “catch up” to the emissions problem. What is more, to be economically sustainable, the solution(s) will require that large emitters (such as utilities) have a ready, reliable, long-term access to a large aggregated supply of emission reductions that can be used to offset their emissions.

Yet “easily generated” industrial abatement and avoidance environmental emission removals are nowhere near sufficient to supply the worldwide demand that is now being created by regulations/legislation. What's more, as the petroleum industry has recently demonstrated, aggressive reductions are expensive. One industry leader notes (in their corporate website) that their 2001 internal GHG emission reduction costs averaged $39.63/ton CO₂ equivalent; 2002 internal GHG emission reduction costs averaged considerably more.

Further complicating the process of creating, aggregating and transferring (selling) environmental emission removals, few formal standards have been promulgated to specify these steps or to provide reference baselines. Until the recent past, for instance, a putative purchaser of environmental emission removals and a “qualified” supplier of such removals worked together on an ad hoc basis, mutually defining the characteristics of a particular supply contract. The environmental emission removals were created to mutually determined (private) standards, were sometimes inspected or verified by 3^{rd} party agencies, such as environmental engineers, environmentalists, or accounting firms, and were privately exchanged. These trades were executed on a project-by-project basis, and were often shrouded in secrecy—unless the buyer desired to publicize the event to garner positive Public Relations value.

Recent regional and sub-national climate change legislation establishes reference baselines, against which emissions levels can be specified. It does not, however, unambiguously specify how to qualify/quantify GHG ERCs, registration mechanisms and standards, etc.

The issues are complex. Many individual production operations, for instance, have limited environmental emission removal creation/generation capacity; often, individual sites are unable to produce a quantity (to meet or exceed their own internal mitigation needs) to be economically useful to large purchasers of environmental emission removal units. In addition, entities who “need” large quantities of these offsets have to be concerned with a number of issues pertaining to aggregating a substantial quantity of them, such as: contracts and pricing standardization, title/ownership conveyance issues, quality assurance issues (statistical error bounding, data permanency and verification, etc.), additionality, leakage, environmental emission removal registration and retirement, risk mitigation, and more. Historically, it has been impractical for large purchasers of environmental emission removals to assume the overhead associated with addressing all these issues.

In addition, projects for creating/supplying environmental emission removals often lack adequate quality assurance provisions. For instance, even for those trades that impose some level of quality control—such as site audits or data verification—no means has been used (beyond the integrity/certification of the company or individual auditor, that is) to actually prove that a site audit took place. In many instances records are paper based and are not secured.

While Kyoto's Clean Development and Joint Implementation Mechanisms establish highly prescriptive means for invoking quality assurance in individual GHG projects, they do so in a “high friction” way—that is, with a significant “per offset” cost penalty.

What is needed is a system that inexpensively develops environmental emission removals while satisfying global credibility tests.

### SUMMARY OF THE INVENTION

Embodiments of the present invention provide an integrated, holistic methodology that may enable a systematic creation, aggregation, verification, registration, storage, transfer/sale, and retirement of environmental emission removal units. Such methodology provides a control and management system that complements the use of sound foundational science to qualify and quantify environmental emission reductions and removals.

An embodiment of the invention may include selecting at least one producer from at least one of a plurality of production sectors including agriculture, forestry, petroleum and/or gas production (including enhanced oil recovery), fuel production (including ethanol production), semiconductor manufacturing, metal production, coal production, deep geologic sequestration, durable goods manufacturing, and waste management (including landfills). One embodiment may include selecting a plurality of producers from one or more governing jurisdictions.

Embodiments of the system may be applied preferentially to sectors capable of generating large quantities of surplus environmental emission removal units, which can be transferred to companies or sectors that desire to manage their environmental emissions compliance in an inexpensive manner, or can be used generally—in any sector—to ensure that a uniformly high—and consistent—standard is used to qualify and quantify reductions.

The system may include comparing producer qualification data to pre-selected criteria to determine producer eligibility for evaluating producers that can most easily realize significant environmental emission reductions or removals.

The system may include “pre-assessing” producer operations, such as collecting production, size, and infrastructure pre-assessment data, selecting at least one of a plurality of protocols appropriate to the producer operations, collecting available external information sources regarding the producer and its operations, and having a producer representative warrant the data and/or data collecting process.

By pre-assessing producer operations, data collection and assessment activities are enhanced. By way of example, pre-assessment makes it possible to optimize template formation, by contemplating all likely protocols that can be applied to realize environmental emission reductions and removals, choosing those most applicable to producer operations. When a producer implements specific production practices, co-benefits will be generated along with environmental emission reductions and removals.

Methods may include collecting production practice data, which is later processed to qualify and quantify environmental emission removal units. The collecting of production practice data may include gathering externally available information and onsite data regarding the producer.

One embodiment may include forming an assessment team for collecting information regarding the type of producer, the protocols, and prerequisite qualifications and certifications for assessors. Data collecting equipment may include the use of electronic data instruments that may enhances the process of collecting and transferring data in a reliable, efficient manner. It is possible to use such electronic data instruments to collect a producer's warrant that proper site data collecting and security procedures were followed, which forms the basis of a release of legal liability relative to specific issues. In the case of an agricultural producer, for instance, this warrant can certify that a data collecting entity followed proper bio-security protocols.

The system may include transferring the production practice data to a data center, wherein transferring data may include transmitting and/or encrypting the production practice data, and receiving the production practice data, which may include decrypting the production practice data and/or securing the data and restricting access. Methods may include confirming that the received production practice data meets a pre-selected data standard, including data integrity, data completeness, and testing the production practice data's eligibility for processing, such tests including reviewing for non-conforming processes.

The system can be queried by authorized entities to determine and report on specific producer data or compliance issues, relating any production practice data contained in the data warehouse or available through external sources. Labeling may include signage for qualified producers, wherein the signage indicates that the producer has been reviewed and is in good standing.

One method embodiment may include modifying the environmental data to effective environmental data, wherein the modification may account for error models and/or data variances with the variances including protocol related variances. Further, the method may include taking title to the effective environmental data, wherein title may be taken by other than the producer.

The taking of title to the effective environmental data by an entity other than the producer makes it possible to sever producer reliability, whereby the producer is kept at arms length from transactions involving the long term commitment to transfer environmental emission removal units into the hands of another entity. The system may also include allocating a first portion of the effective environmental data to a reserve pool. The system may include providing guidance to the producer for enhancing production practices responsive to the production practice data.

Providing guidance to the producer is desirable and may be used to help the producer optimize production, correct non-conforming conditions, and to achieve superior environmental performance.

Further, converting the production practice data to environmental data using pre-selected conversion factors includes the use of protocol related conversion factors such as GHG emission reduction factors.

The system may include aggregating the production practice data from a plurality of producers, wherein the plurality of producers includes one or more of a plurality of farms, ethanol production plants, coalmines, landfills, or other production sector units. Moreover, each of the plurality of producers may include at least one common production practice, wherein the aggregating of production practice data includes selecting a protocol for the at least one common production practice.

Method steps within an embodiment of the invention may include registering the effective environmental data and converting the effective environmental data to an environmental emission removal unit. Registering of data may include verifying the commercial suitability of the effective environmental data, recording the registering, designating the ownership of the environmental emission removal unit, assigning a unique identifier, which may be a protocol related identifier, may provide either temporal or spatial information regarding the production practice that caused the environmental emission reduction unit to be created (including geo-referenced coordinates), may include specific emission removal unit accounting, or which may include full or partial encryption, and includes the case wherein a unique identifier may consist of a serial number, which may be derived relating to such parameters as those mentioned herein.

The system 100 may be used to correlate an externally assigned identifier to internal data and/or identifiers. In addition, all collected data relative to one or more environmental emission removal units may be correlated.

Converting the effective environmental data to an environmental emission removal unit includes converting to an offset, credit, or allowance, depending on restrictions imposed by the relevant environmental (emission) regime, and may include choosing a registry (or registering) jurisdiction, including to enable the “use” of the environmental emission removal unit in a particular jurisdiction. .

Another aspect of the system is to enable multi-national emitters that purchase environmental emission removal units to purchase them in one governance jurisdiction and to transfer them internally to another division (in another governance jurisdiction) to achieve a lower overall compliance cost than might otherwise be possible. The system may include contracting to transfer the title of a plurality of environmental emission removal units within a time period, which may include allocating at least a portion of the reserve pool for mitigating transfer risk, and/or assigning title to at least a portion of the reserve pool for mitigating transfer risk, and/or transferring title for at least a portion to an escrow account.

Through the process of contracting to transfer the title of a plurality of environmental emission removal units within a time period, the system makes it possible to enter into forward sale contracts. Because the system makes it possible to take title to a producer's data, it is possible to sever producer risk from the obligations incurred by contracting to transfer the title of a plurality of environmental emission removal units within a time period.

The system may include the selling of one or more of a plurality of environmental emission removal units on standardized terms, which may include establishing a pool of environmental emission reduction units, wherein the pool is accessed during a point of sale event for reducing at least a portion of the environmental emissions resulting from the point of sale event or service. In another example, a pool of environmental emission reduction units may be established for investment purposes.

The system may include transferring the title of one or more environmental emission removal units for offsetting at least a portion of the environmental emissions from an emitter, or a plurality of emitters. Yet further, embodiments may include the allocating of environmental emission removal units from a plurality of producers of a controlling entity for offsetting at least a portion of the environmental emissions of the controlling entity.

By way of further example, one method aspect of the invention may include a method of processing environmental emissions. Which method comprises selecting a producer of at least one of environmental emissions and environmental emissions removal; comparing a production practice of the producer to pre-selected qualification criteria; contracting with the producer regarding implementation of the production practice; selecting a protocol sufficient for comparing the production practice to a baseline practice; collecting production practice data regarding the producer responsive to the protocol; warranting the production practice data by the producer; confirming the received production practice data meets a pre-selected data standard; converting the production practice data to environmental data using pre-selected conversion factors; taking title to the effective environmental data by other than the producer; modifying the environmental data to effective environmental data; crediting the producer for at least a portion of the effective environmental data; and registering the effective environmental data for commercial use thereof.

### BRIEF DESCRIPTION OF THE DRAWINGS

Embodiments of the invention are described by way of example with reference to the accompanying drawings in which:

FIG. 1 is a flow diagram illustrating one embodiment of a system for processing environmental emissions in keeping with the teachings of the present invention;

FIG. 2 is a flow diagram expanding upon optional steps within the system process flow of FIG. 1;

FIG. 3 is a flow diagram illustrating one embodiment of a supply aggregation process;

FIGS. 4A-7 include flow diagrams illustrating pre-contract, post contract, scheduling, and site assessment processes respectfully for the aggregation process of FIG. 3, wherein FIG. 4A illustrates, by way of example, external interactions and FIG. 4B internal interactions;

FIG. 8 is a system block diagram illustrating a quality assurance aspect of the system of FIG. 1;

FIG. 9, comprised of FIG. 9A and FIG. 9B, is a process flow diagram specifying quality assurance procedures for an embodiment of the system herein described by way of example;

FIG. 10 is a flow diagram illustrating a template creation, by way of example;

FIG. 11 is a block diagram illustrating one data management and information technology infrastructure for an embodiment of the system herein described by way of example;

FIG. 12, comprised of FIG. 12A and 12B, is a flow diagram illustrating one embodiment of information flow within the system herein described by way of example;

FIGS. 13-15 include flow diagrams illustrating process embodiments for pre-generation, eligibility and data testing, and creation and allocation, respectively, for creating emission reductions, environmental emission removal units, and associated co-benefits; and

FIGS. 16-18 include flow diagrams illustrating inventory, search and registry, and sale process flows, respectively, for the system herein described by way of example.

### DETAILED DESCRIPTION OF THE PREFERRED EMBODIMENTS

The present invention will now be described more fully hereinafter with reference to the accompanying drawings, in which embodiments of the invention are shown, by way of example. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

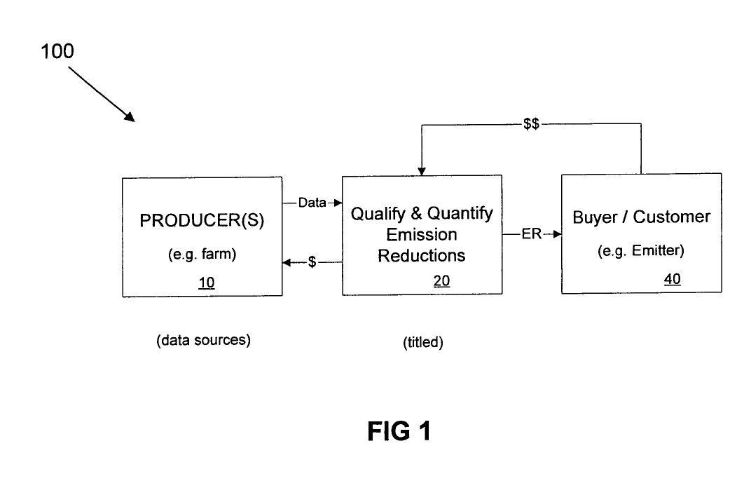

Referring initially to FIG. 1, embodiments of the present invention will develop an integrated, holistic methodology known as the system 100 that enables the systematic creation, aggregation, verification, registration 30, storage, transfer/sale, and retirement of environmental emission removal units 32. This methodology establishes the underlying control and management system that complements the use of sound foundational science to qualify and quantify environmental emission reductions and removals 20. It provides the framework for accurate data collecting 24, storage, and processing 26, establishes rigorous quality control 300, requires various “checks and balances”, including third party verification, tests the results, and is based upon the tenets of full accountability and data transparency. As illustrated with reference to FIG. 1, system 100, viewed at a high level, is comprised of producer(s) 10, a qualification and quantification process 20, and emitters/customers 40. As illustrated herein by way of example, payment may be caused to producer(s) 10 for receipt and use of information that enables further processing 26, which may result in the creation of environmental emission removal units 32. After processing 26, Emission Reductions (ERs) 28 and/or environmental emission removal units 32 (whether associated or not with co-benefits 34) may be transferred to emitters/customers 40.

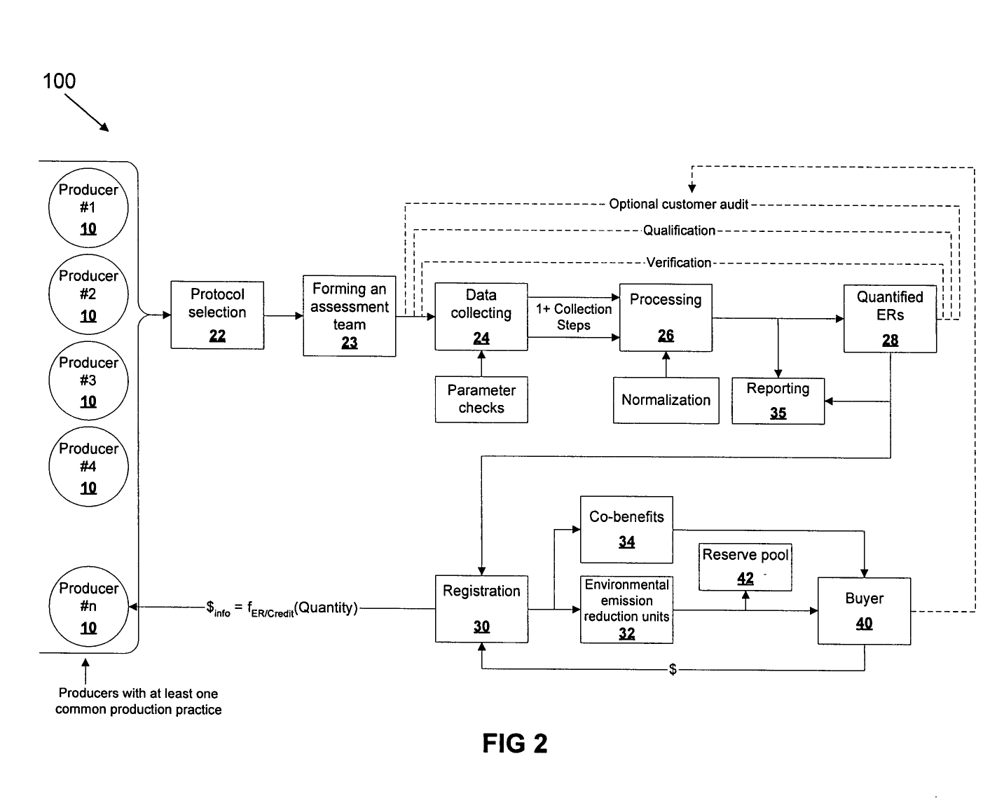

FIG. 2 depicts the system 100, resolved into additional steps. As illustrated, the system 100 includes selecting at least one producer 10 from at least one of a plurality of production sectors including agriculture, forestry, petroleum and/or gas production (including enhanced oil recovery), fuel production (including ethanol production), semiconductor manufacturing, metal production, coal production, deep geologic sequestration, durable goods manufacturing, and waste management (including landfills). At least one protocol is selected 22, an assessment team is formed 23, and the at least one protocol is selected 24 and used to guide the process of gathering data, which is then processed and converted 26, yielding quantified emission reductions 28. The quantified emission reductions 28 undergo a registration process 30 and may be transferred, by way of example, to a buyer 40 or reserve pool 42. FIG. 2 also shows various quality control and quality assurance checks, including audit, qualification and verification loops.

The system 100 may include selecting a plurality of producers 10 from at least one of a plurality of governing jurisdictions. While some sectors may have a higher per location (or aggregate) capacity to produce environmental emission removal units 32 than other sectors, the same management system is applicable to many sectors.

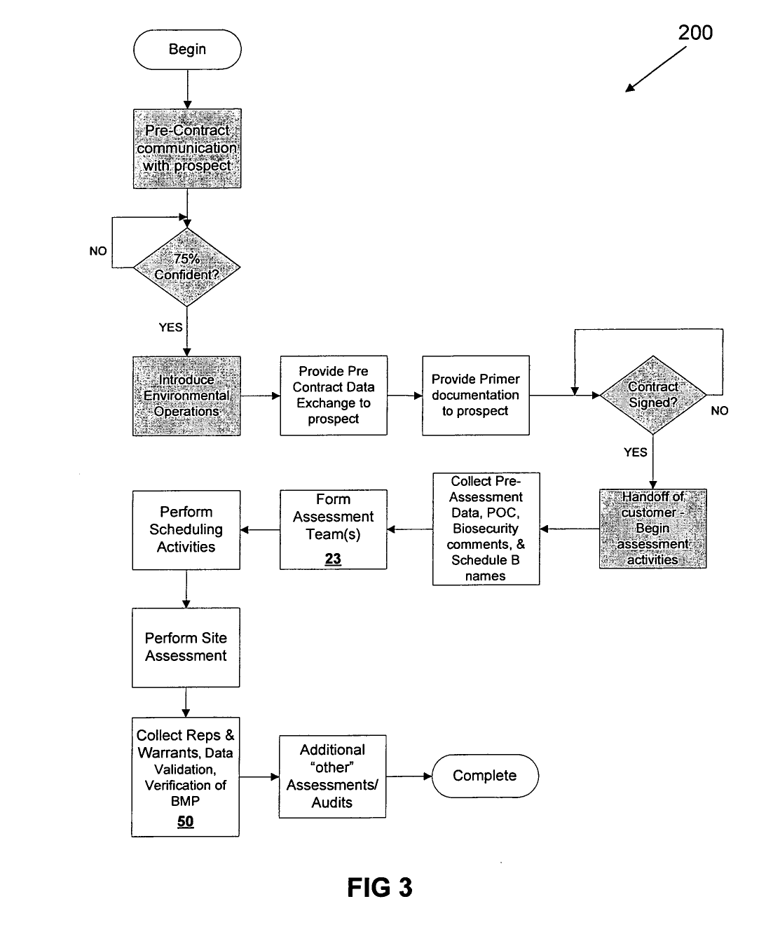

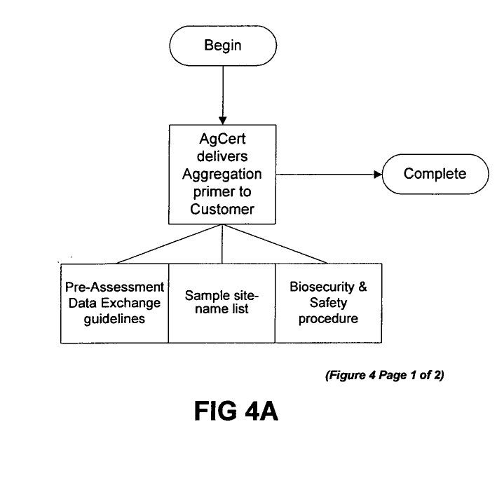

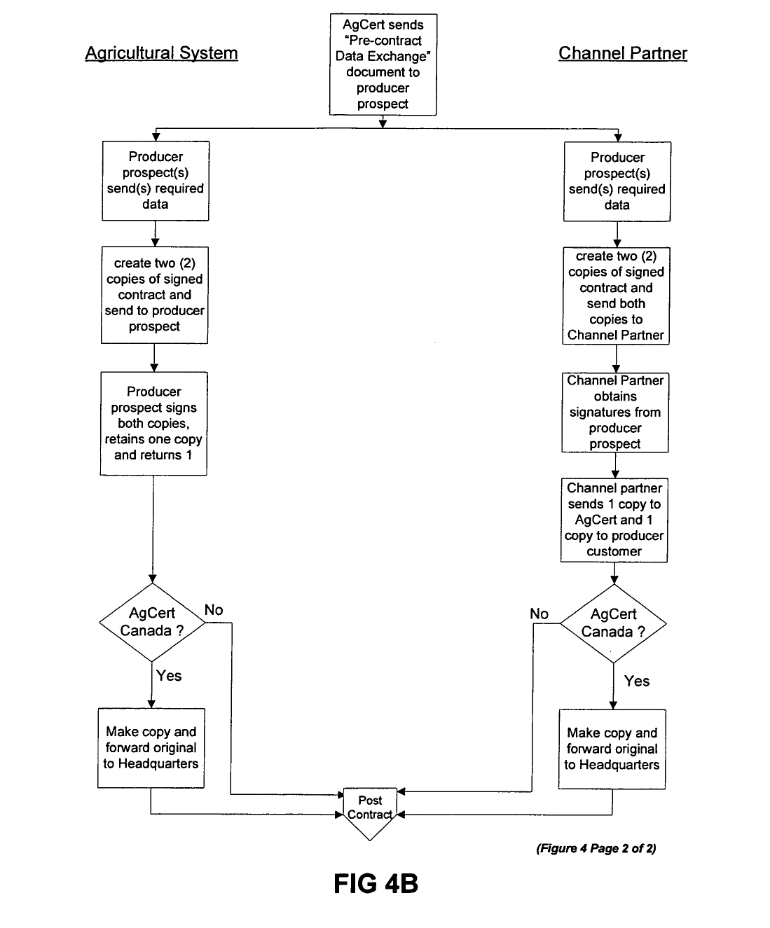

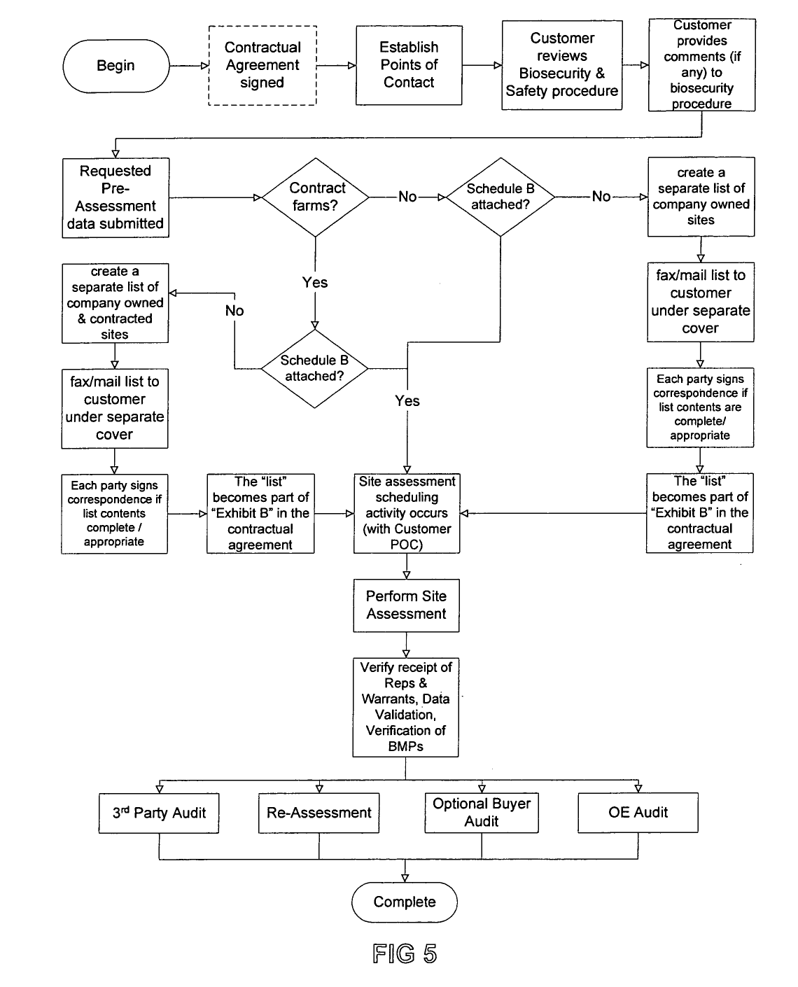

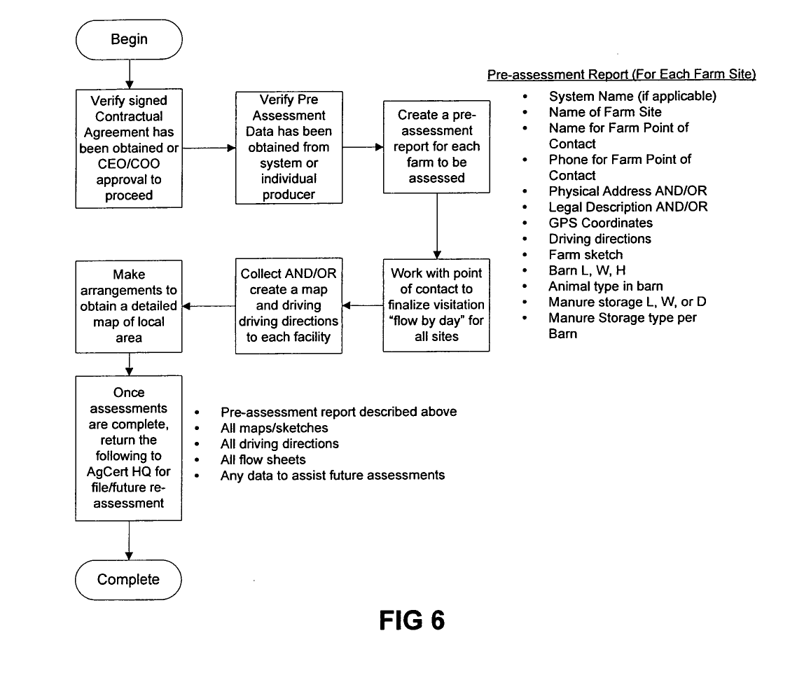

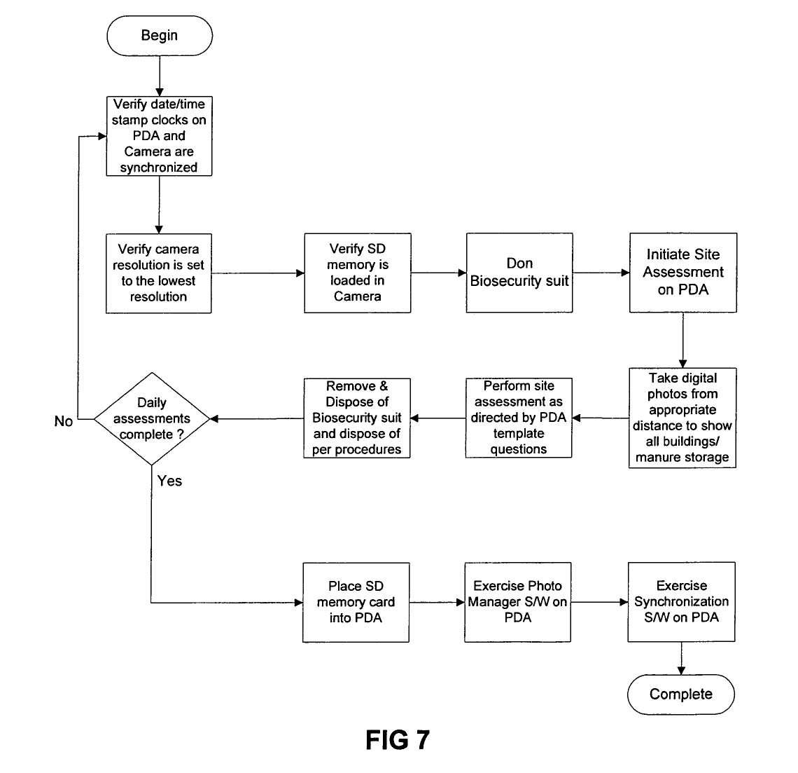

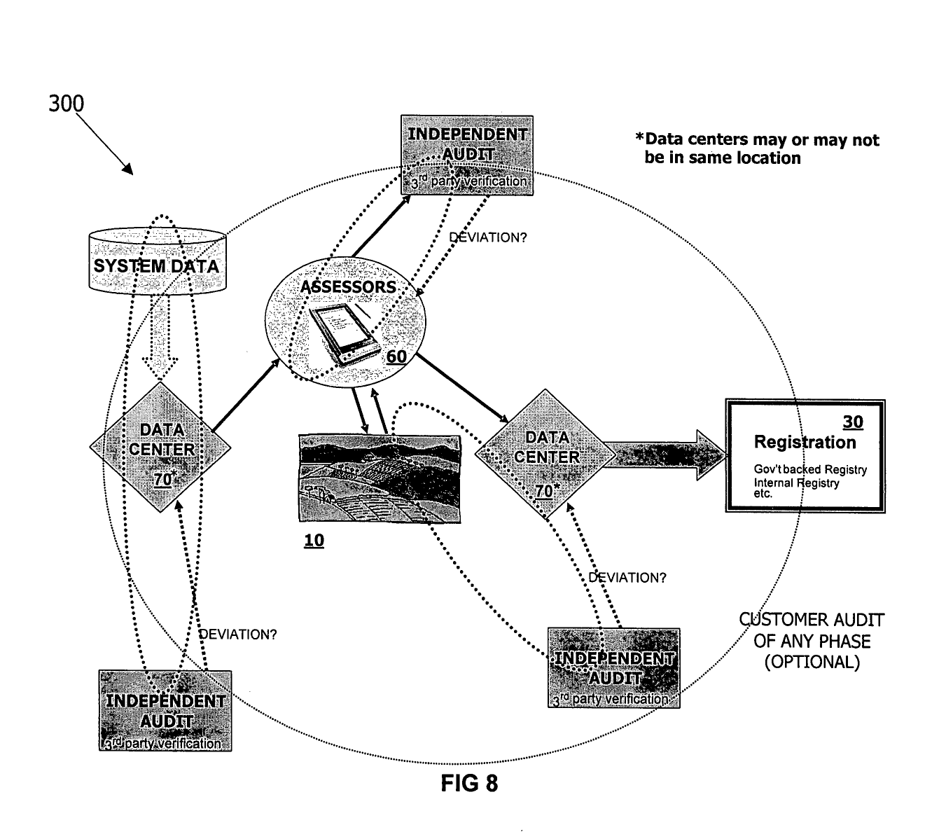

As illustrated with reference to FIG. 3, the aggregation system 200 includes pre and post contract flows, scheduling flows, and a site assessment flow. This process flow includes the collecting of “reps and warrants” 50, an important step in releasing liability. FIGS. 4-7 detail additional steps to the aggregation system 200. FIG. 4 is an exemplary pre-contract process flow, comprised of FIG. 4A (external interactions) and FIG. 4B (internal interactions). FIG. 5 is an exemplary post-contract process flow, including various audits that may occur. FIG. 6 is an exemplary scheduling process flow. FIG. 7 is an exemplary site assessment flow. As referenced in FIGS. 3-5 and FIG. 7, bio-security procedures are followed as appropriate. The collecting of data 24 may occur at one or many different points in the flow.

As illustrated with reference to FIG. 8, the quality assurance system 300 is comprised of checks and balances, including both internal and external audits, such as third party verification. As shown, the data center 70 may be situated in one or many locations.

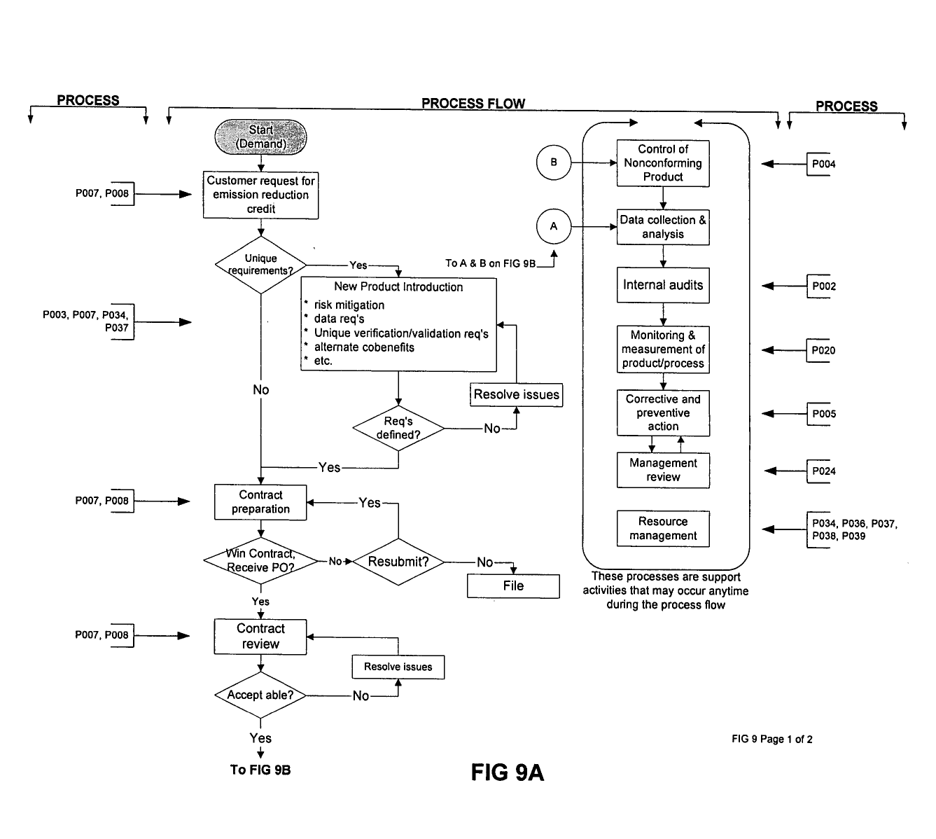

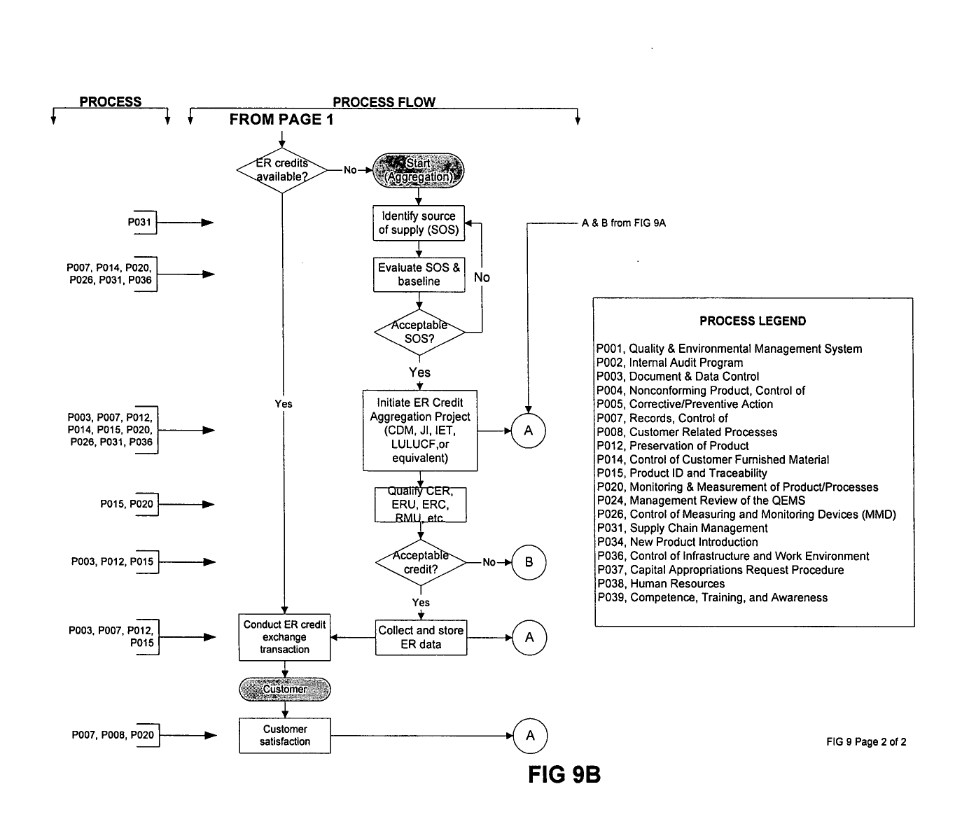

As illustrated with reference to FIG. 9, comprised of FIG. 9A and FIG. 9B, a number of procedures and process steps (and associated documents) are required to implement a robust quality assurance program that operates across the entirety of the system 100.

The system 100 can be applied preferentially to sectors capable of generating large quantities of “surplus” environmental emission removal units 32, and not just agriculture, herein described by way of example, which can be transferred to companies or sectors that desire to manage their environmental emissions compliance in an inexpensive manner, or can be used generally—in any sector—to ensure that a uniformly high, and consistent, standard is used to qualify and quantify reductions 20.

The system 100 may include comparing producer qualification data to pre-selected criteria to determine an eligibility of the producer 10. For instance, in the agricultural sector, this process may include considering whether a producer 10 is an intensive livestock operation, what kind and quantity of animals are raised, and producer management baseline practices. By way of another example, in the petroleum sector, this process may include considering whether a producer 10 produces both oil and gas, whether the gas is captured versus flared, and whether the oil extraction requires enhanced recovery (injection) techniques.

By implementing a “qualification” step, it is possible to focus system resources on producers 10 that are can most easily realize significant emission reductions/removals, to optimize the production of a significant quantity of environmental emission removal units 32.

The system 100 may include contracting with the at least one producer 10 regarding the undertaking of production practices that may produce environmental emission removal units 32. This step establishes a formal relationship between an entity that is entitled to apply the system 100 and a producer 10 that is willing to undertake production practices that realize changes in environmental emissions relative to a baseline. In the event that an entity already owns a number of producers 10 that are capable of undertaking production practices that realize changes in environmental emissions, this step may be unnecessary.

The system 100 may include “pre-assessing” producer operations including the collecting of data 24 such as production, size, and infrastructure pre-assessment data, selecting at least one of a plurality of protocols 22 appropriate to the producer operations, collecting available external information sources 24 regarding the producer 10 and its operations, and having a producer warrant the data and/or data collecting process 50.

In this context, a protocol may include general guidance on environmental emissions and environmental emissions reduction measurement methodologies, indirect measurement criteria, modeling criteria, baseline definitions (including calendar, practice-based, and performance based criteria), data taking practices/standards, conversion factors, including IPCC Global Warming Potential (GWP) conversion factors (to enable equivalent comparison of different greenhouse gases in terms of carbon dioxide equivalents), and verification criteria. The protocol may be a government certified or approved protocol. The protocol may provide only for the qualification and quantification 20 of environmental emission removal units 32, or it may also accord recognition to other co-benefits or co-products 34, including cleaner air (e.g. reduced odor), cleaner water, reduced land erosion, co-generated electricity, and/or land-use benefits (e.g. enhanced soil health attendant to specific crop growth or crop rotation).

The system 100 can track (or designate) whether a protocol is approved or certified by a specific government or other entity (such as World Bank), as such designated “recognition” has been determined important to certain buyers 40 of environmental emission removal units 32.

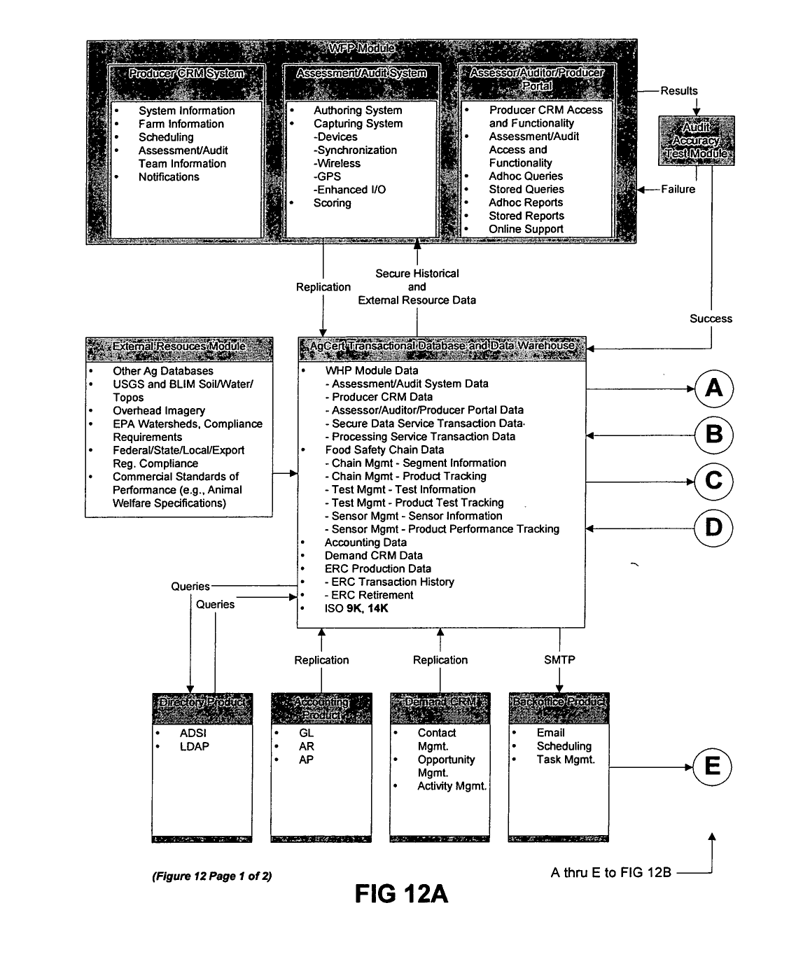

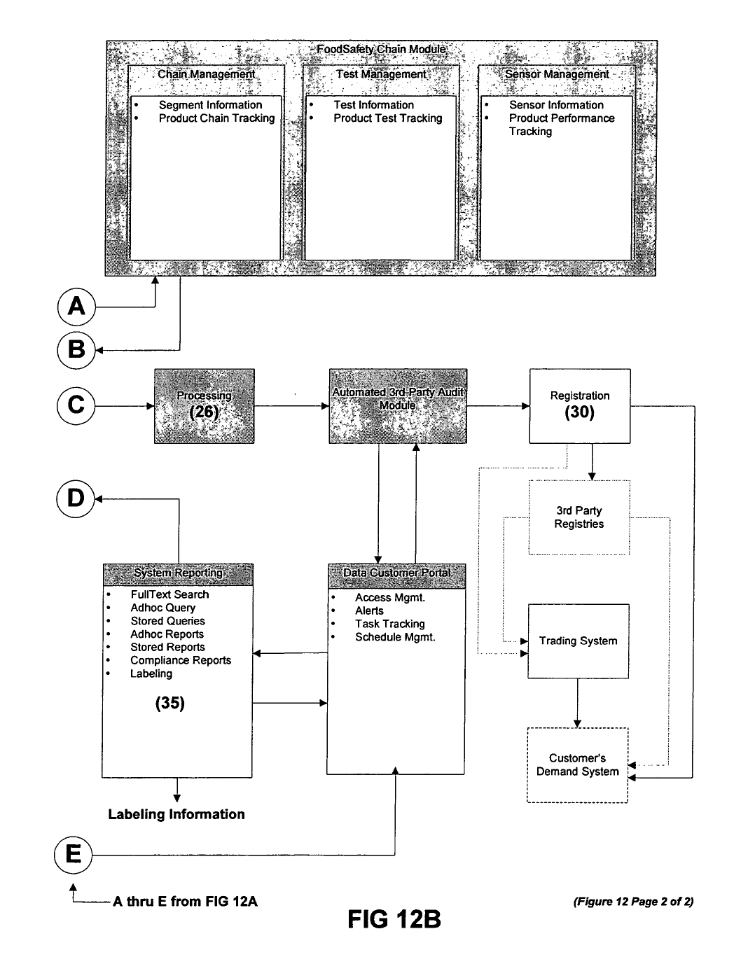

The collecting of external information source data 24 may include site physical data, including cropping maps, soil maps, watershed maps, topographical maps, geo-reference data 25 (i.e., latitude/longitude coordinates), site permit data, such as TMDL permits, total site capacity permits, building permits, and air emissions permits, overhead photography, including both infrastructure placement and dimensional data (provided the photography is ortho-rectified), information on commercial performance metrics/practices, such as production throughput, production capacity, and animal welfare practices/standards. Such data is illustrated with reference to FIG. 6 and FIG. 12A and 12B.

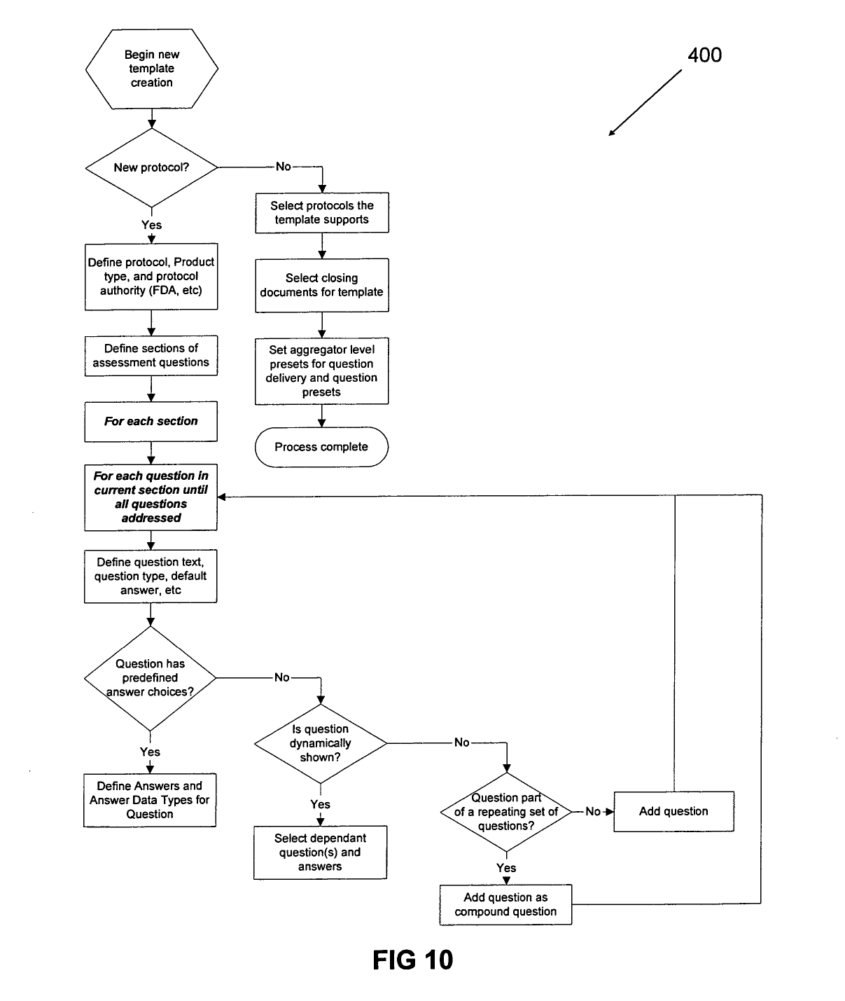

By pre-assessing producer 10 operations, it is possible to optimize and enhance subsequent onsite data collection and assessment activities 24. Pre-assessment makes it possible to optimize the template formation process 400, illustrated with reference to FIG. 10, by contemplating all likely protocols that can be selected/applied 22 to realize environmental emission reductions and removals—choosing those most applicable to producer operations. When a producer 10 undertakes specific production practices, co-benefits 34 will be generated along with environmental emission reductions and removals. Because it may be desirable for buyers 40 of environmental emission removal units 32 to selectively choose those reduction units that created co-benefits 34, some protocols will acknowledge co-benefit production. As will be further described later in this section, there may be a process flow wherein a buyer 40 can search for and reserve certain classes of environmental emission removal units 32 including those with co-benefits 34, including transferring available designated inventory to registration.

Pre-assessment activities sometimes have the positive effect of providing necessary data ahead of the onsite data collecting activity 24. For pre-supplied data, it is only necessary that the assessor verify the data (as opposed to discovering and collecting it) during the collecting of production practice data 24. It also makes it possible to have a producer 10 who has supplied specific data warrant the accuracy of such data. Such a “rep and warrant” 50 can be extremely useful to an entity practicing the system 100 as it releases said entity from significant legal liability relating to producer's errors and omissions.

The system 100 includes collecting production practice data 24, which are later processed 26 to qualify and quantify environmental emission removal units 32. The collecting of production practice data 24 may include gathering externally available information and onsite data regarding the producer as earlier described with reference to FIG. 6 and FIGS. 12A and 12B. All data that is required to either qualify or quantify environmental emission reductions/removals and/or confirming information that is required by a third party verifier is collected.

In the collecting of production practice data 24, external information sources may include site physical data, including cropping maps, soil maps, watershed maps, topographical maps, geo-reference data 25 (e.g. latitude/longitude coordinates), site permit data, such as TMDL permits, total site capacity permits, building permits, air emissions permits, overhead photography, including both infrastructure placement and dimensional data (provided the photography is ortho-rectified), information on commercial performance metrics/practices, such as production throughput and/or capacity, and animal welfare practices.

The collecting of onsite data 24 regarding the producer 10, shown by way of example as a farm or farm system in FIG. 8, may include amassing data provided by the producer, forming an assessment team 23 for onsite collecting and/or confirmation of site data 24, entering the data into at least one pre-selected template which is based upon selecting at least one of a plurality of protocols 22, and which includes questions related to at least one protocol, commercial standard, environmental compliance, non-conformance, and/or business need, and may include entering—concurrent with entering the site data into at least one pre-selected template—geo-reference 25 and time information, which itself may include using a Global Positioning System (GPS), cellular communications network or analogous system with geo-referencing/tracking capabilities to track the presence and progress of the assessor on the site, and may include using an electronic data instrument 60, such as a PDA or electronic notebook to record the data. This electronic device 60 used for recording data may include access or security provisions to enable authorizing use of the instrument for data entry and/or subsequent data transmission. The data entry process may also include modifying the at least one pre-selected template to document non-conforming producer practices or conditions. In addition, the collecting of onsite data 24 regarding the producer 10 may include amassing commercial performance data such as production throughput, production capacity, and/or animal welfare practices, and may include the producer's warranting of onsite data collecting 24 with respect to known production practices, wherein the producer's issuing of a rep and warrant 50 may be a legal release of liability for data collecting, including a release for liability relating to bio-security issues.

In some production sectors, the presence of (or visitation by) non-production related personnel is undesirable, for reasons of liability, physical or data security, and so forth. The system 100 may be used to minimize visits by other service providers making it possible for assessors to gather other supply-chain or commercial standards compliance information during the collecting of production practice data 24.

The forming of an assessment team 23 considers a number of factors, including the type of producer 10, the protocols, and prerequisite qualifications and certifications for assessors. Further, it considers the data collecting equipment that may be used, and the assessor's familiarity with this equipment. All choices are made to optimize the quality and consistency of the collected data, to ensure that all claimed output results are justified and defensible.

The data collecting equipment may include the use of electronic data instruments 60 running a combination of “off the shelf” and customized software, including pre-selected protocol templates such as earlier described with reference to FIG. 10. The use of such equipment makes it possible to include “security” provisions that prevent non-authorized personnel from either accessing the system (threatening data security) or entering incorrect production data (jeopardizing data integrity). It also enhances the process of collecting and transferring data in a reliable, efficient manner. It is possible to use such an electronic data instrument 60 to collect a producer's “rep and warrant” 50 documenting that proper site data collecting 24 and security procedures were followed, forming a release of legal liability relative to specific issues. In the case of an agricultural producer 10, for instance, this warrant can certify that an assessor followed proper bio-security protocols.

The system 10 may include transferring the production practice data to a data center 70, wherein transferring data may include transmitting and/or encrypting the production practice data, and receiving the production practice data, which may include decrypting the production practice data and/or securing the data and restricting access.

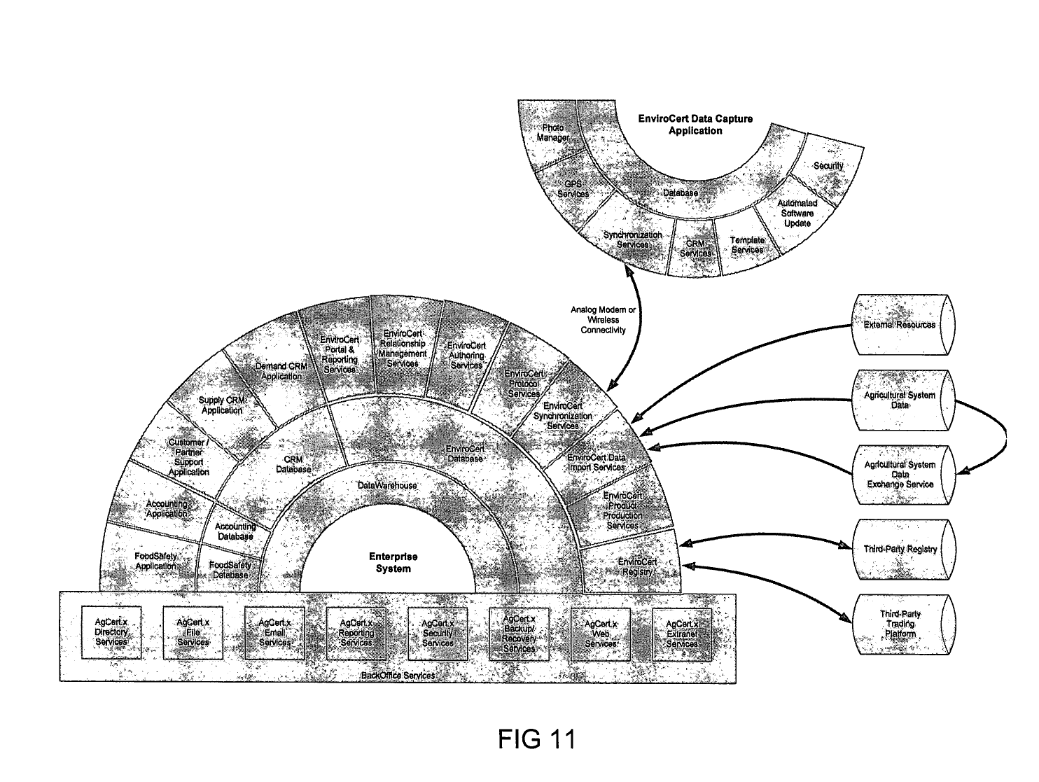

FIG. 11 illustrates, by way of example, the data management and information technology infrastructure for the data collection instrument 60 and data center 70 including an enterprise system and data warehouse, comprised of functional software modules, applications, databases, and services including the communications and synchronization link(s) between 60 and 70.

FIGS. 12A and 123 illustrate the flow of information in the enterprise system including the interrelationship of functions such as customer relationship management, scheduling, external resource management, reporting 35, auditing, registration 30, and transfer of information or environmental emission removal units 32.

The data transferring process can be automated—keyed by certain events, such as placing the electronic data instrument 60 back in a charging cradle subsequent to use and/or while detecting the presence of a communications medium, such as an available phone line or wireless link—or it can be manually initiated. In the case of non-electronic data collecting, transferring may consist of sending hard-copy records. The data center 70 may consist of one site or many, and the data center 70 may be “mirrored” by other data centers 70 for reliability purposes—that is, the data, in part or whole, may be stored in multiple data centers 70 simultaneously.

The system 100 includes confirming that the received production practice data meets a pre-selected data standard, including data integrity, data completeness, and testing the production practice data's eligibility for processing 26. Such tests may include reviewing for non-conforming processes, reviewing for appropriate producer contract terms, reviewing pending environmental conditions and/or actions against the producer, comparing production practices, documented through the collection of data, to a baseline practice, and determining an acceptable status for a third party audit. In addition, the system 100 includes reporting 35 the production practice data, including comparing the production practice data to standards of performance, and may include identifying production practice compliance through labeling, wherein the label may include government approval, may confer a regulatory shield, or may identify the source of the conditions conferring compliance (e.g. the source of the environmental removal units), and includes converting the production practice data to environmental data using pre-selected conversion factors. Labeling is shown, by way of example, in FIG. 12B.

The system 100 includes provisions for processing 26 production practice data—even if it does not satisfy all eligibility tests—so long as the results are kept separate from processed data that met all such tests. This feature can be used, for instance, to inform a producer 10 of the quantity of environmental emission removal units 32 that will be attributed to his production practices, once specific additional actions (such as correcting a non-conformance, repairing a contract, etc.) are met. This feature may provide additional incentive for a producer 10 to ensure his practices meet all system tests. Additionally, this feature enables forecasting the future availability of environmental emission removal units 32 from specific producers 10 and/or sectors.

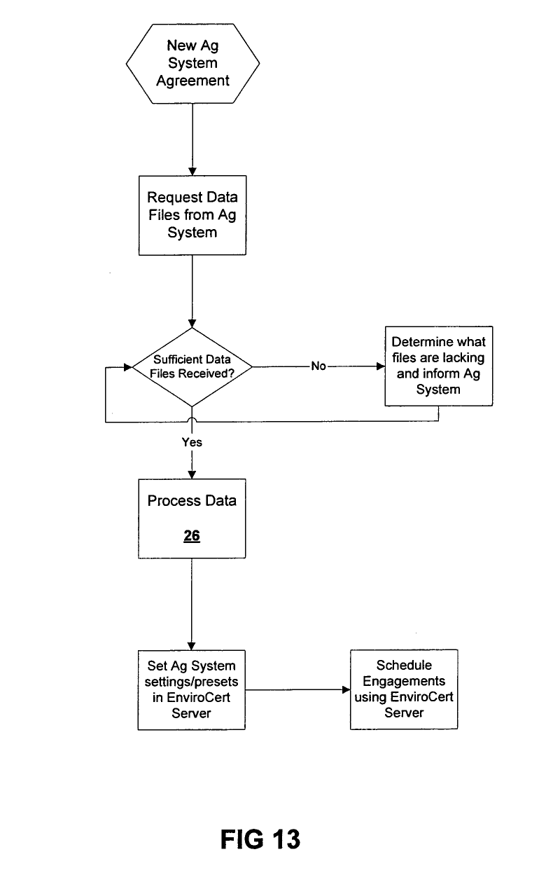

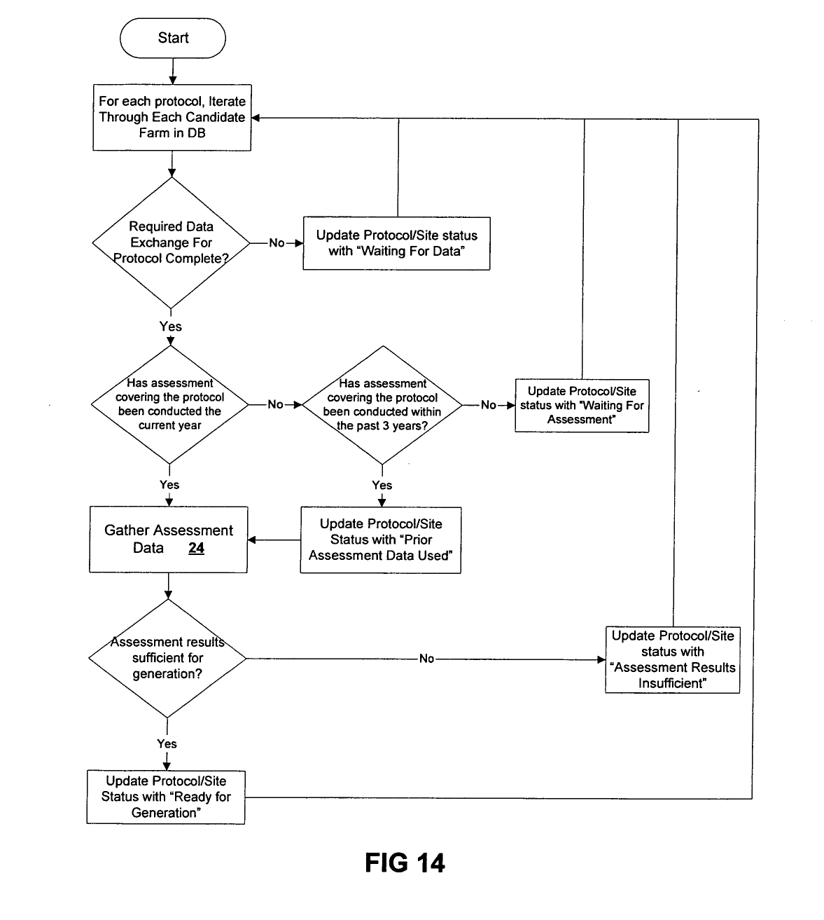

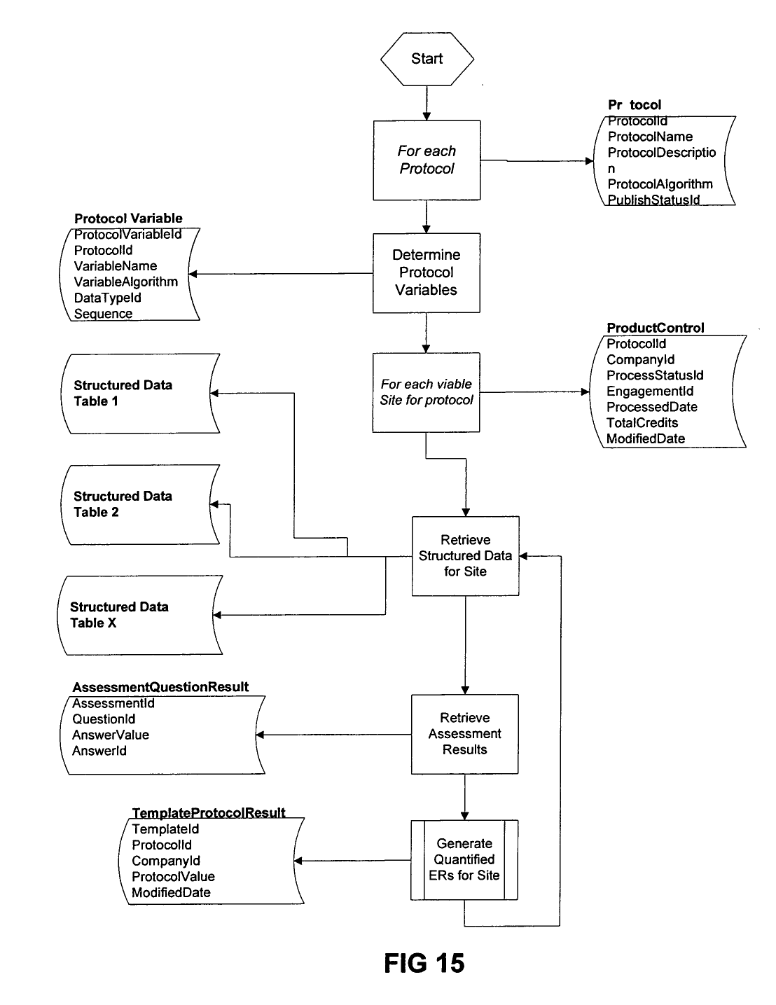

FIGS. 13-15 illustrate system data flows and processing 26 for the creation of emission reductions 28, environmental emission removal units 32, and associated co-benefits 34. FIG. 13 is an exemplary pre-generation process flow. FIG. 14 illustrates control processes including eligibility and data testing. FIG. 15 illustrates a creation and allocation flow.

Another aspect of the system 100 is its ability to reserve specific producer capacity—or types of producer capacity—for use in satisfying specific environmental needs, whether the need is current or future. For instance, this might take the form of preserving regionally produced environmental emission removal units 32 for use by a nearby emitter, for preserving certain environmental emission removal units 32—which have specific associated co-benefits 34—for use by a particular entity, or for preserving the environmental emission removal units 32 produced by one or a number of Kyoto CDM or JI projects for use by designated entities, or for preserving certain environmental emission removal units 32 for use in a specific application, such as offsetting the manufacturing environmental emissions associated with specific products or services. Through this capability, specific production practice data is associated with specific environmental emission removal unit 32 transfer needs. In a similar example, this ability to designate certain capacity or types of capacity can be used to forecast possible regulatory changes that affect baseline or production practices, for instance. By way of example, governing bodies or NGOs may use this to understand the practical “impact” of a considered policy change.

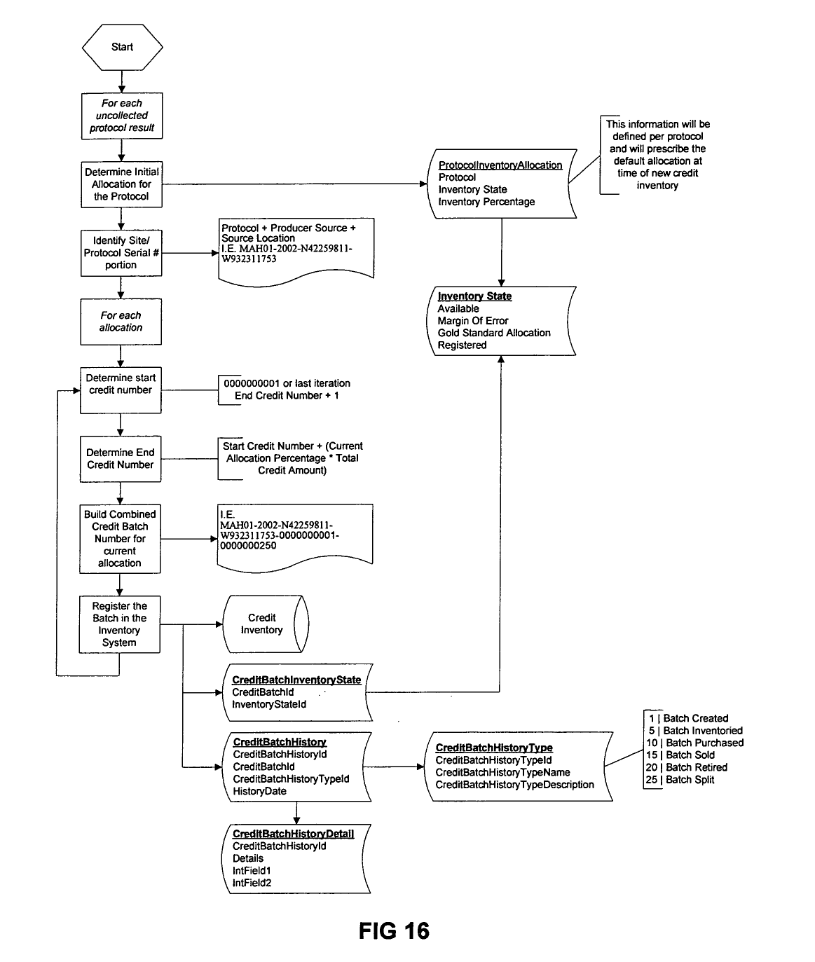

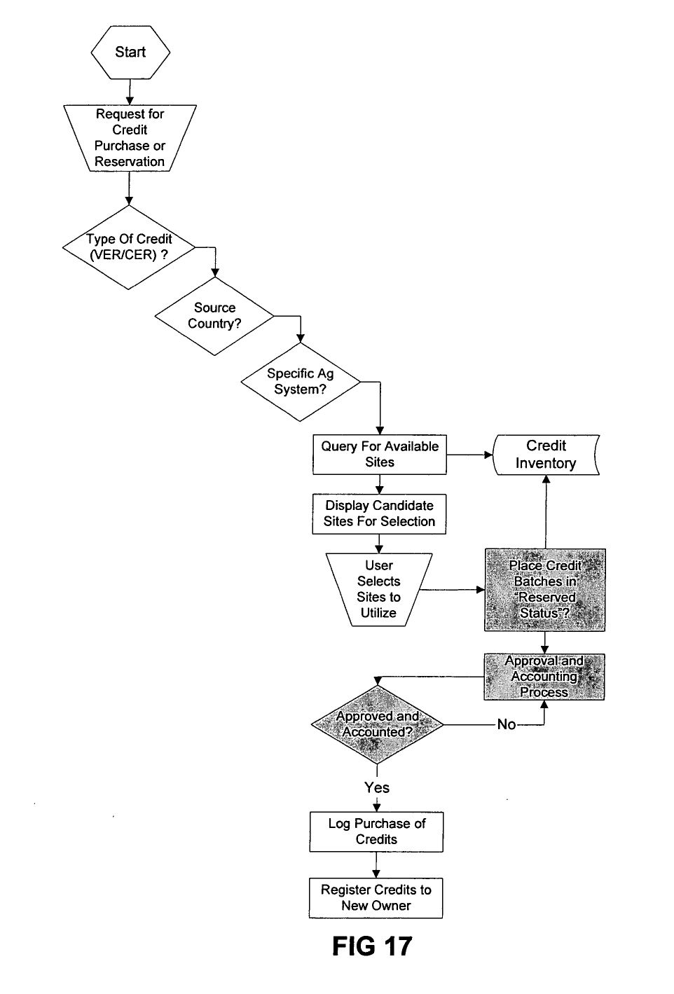

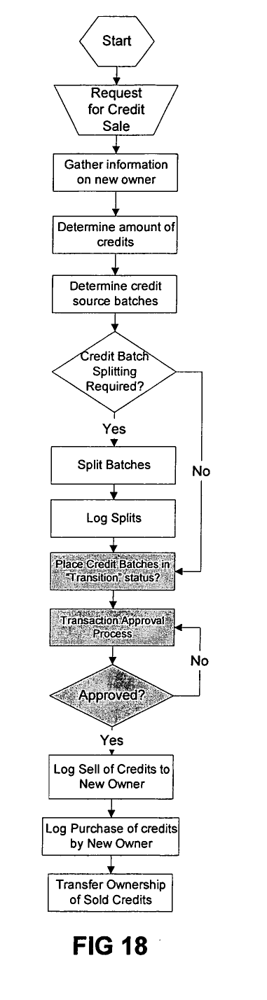

FIGS. 16-18 illustrate system data flows for the inventory and registration processes 30. FIG. 16 illustrates an inventory system. FIG. 17 illustrates an inventory search and reservation process including the transfer of available designated inventory to registration. FIG. 18 illustrates a process for selling registered inventory. In addition, the system includes a variety of reporting functions 35, as illustrated with reference to FIG. 2 and FIGS. 12A and 12B. The system 100 can be queried by authorized entities to determine and report on specific production data or compliance issues, relating any production practice data contained in the data center 70 or available through external sources. By way of example, a financial institution or insurance institution may use this as a prerequisite to granting specific coverage or support. In another example, the report may be used to qualify the producer 10 as a preferred supplier for a given entity. It is becoming common, for instance, for the restaurant industry to impose specific production requirements—such as animal welfare requirements—on their suppliers. Conformance with these requirements can be reported 35 via the system 100. In another example, a third party verifier may want to review the assessment process (including an assessor's progress in data collecting and verifying) by showing the assessor's geo-referenced coordinates 25 plotted onto a map of the producer site.

Labeling may include signage for qualified producers 10, wherein the signage indicates that the producer 10 has been reviewed through the system 100 and is in good standing. Such signage may confer an effective “regulatory shield” to the producer 10, as environmental enforcement agencies/entities are more likely to focus on non-participatory producers 10. Labeling may be used to communicate branding information or product suitability, visibly demonstrating specific environmental attributes with a “seal of approval” that is similar to an UL seal or “Good Housekeeping seal of approval.” Such labeling, for instance, may designate that some or all of a product's manufacturing related environmental emissions have been offset. Moreover, labeling may include information about a producer's (or manufacturer's) products that conveys information about the offsetting or specific form of compliance—including, but not limited to, the source of the offsetting attribute or characteristic. For example, a product label may not only designate that some or all of the product's manufacturing related environmental emissions have been offset, but may also include information making it possible to identify the source of the offsetting environmental emission reduction/removal unit(s) 32.

The system 100 also includes taking title to the environmental data, wherein title may be taken by other than the producer 10, and modifying the environmental data to effective environmental data, wherein the modification may account for error models and/or data variances, including protocol related variances. Typically, in the past, the producer 10 took title to both data and the resulting environmental emission removal units 32. The system 100 makes it possible for an entity other than the producer 10 to take title to data and, subsequent to processing 26, to take title to the resulting environmental emission removal units 32, effectively severing a producer's liability relating to contracts that commit to transfer environmental emission reduction units 32 to a buyer 40. In this example, the entity practicing the system 100 causes payment to the producer 10 for production practice data.

This aspect of the system 100 makes it possible to adjust for intrinsic system errors, such as data collection errors, protocol errors (including conversion errors), data variance, and so forth. It also enables temporal conversion predicated upon “permanence” curves, wherein the value on an environmental emission removal unit declines as a function of time.

The taking of title to the environmental data by an entity other than the producer 10 helps to sever producer liability, whereby the producer 10 is kept at arms length from transactions involving the long term commitment to transfer environmental emission removal units into the hands of another entity. This aspect of the system 100 enables participation in the system by producers 10 who might otherwise be unwilling to participate because of the risks associated with long-term liability.

The system 100 may also include allocating a first portion of the effective environmental data to a reserve pool 42, wherein a portion of the reserve pool 42 may be committed for mitigating delivery risk; the reserve pool 42 including both escrow pools (typically held by a trusted third party), and leveraged instrument pools (e.g. a reserved pool of environmental emission removal units 32 backing a commercial insurance “policy.”). The system 100 may also include committing a portion of the reserve pool 42 to mitigate environmental emission removal unit permanence risk, and includes allocating a second portion of the effective environmental data to the producer 10, which may include providing payment to the producer for the second portion. The system 100 may include providing guidance to the producer 10 for enhancing production practices responsive to the production practice data, wherein such guidance may include providing environmental engineering guidance, directing the producer 10 to use specific equipment or practices, enabling or providing financing to undertake specific equipment and/or practice changes, or how to balance the production of environmental emission removal units 32 against production practice output levels.

The allocation for reserve pools 42 fulfills several important functions. It establishes an environmental emission removal unit 32 reserve that can be used to correct for systemic problems, can be used to bridge a gap between supply and demand (in the case of an expected reduction in supply, say through disease or natural disaster), can be used to offset delivery risk—either through direct escrowing or by an isolated ‘hold back’ pool—can be used as the collateral against which commercial insurance instruments are written, and so forth.

Providing guidance to the producer 10 is an important aspect of the system 100. This feedback can be used to help the producer 10 optimize production, correct non-conforming conditions, and to achieve superior environmental performance. By considering a variety of conditions holistically, the system 100 makes it possible to offer the producer 10 guidance that balances environmental emission removal unit 32 production against the achievement of other factors, or against the production of other specific outputs. In this way the system 100 makes it possible to optimize producer 10 outputs, including profitability and environmental compliance.

Converting the production practice data to environmental data using pre-selected conversion factors includes the use of protocol related conversion factors such as GHG emission reduction factors, which may include such parameters as effluent loading, quantity, type, and age of animals, manure containment storage period, manure containment storage practice, and number of herd turns (annual animal throughput). In another example, such parameters may include flaring volume, flaring efficiencies, gas types, and gas generation rates. In yet another example, such parameters include chemical manufacturing process efficiencies and related emissions. In addition to (or instead of) GHG emission reduction factors, protocol related conversion factors may include clean water environmental emission reduction factors, clean air environmental emission reduction factors, soil erosion reduction factors, and/or animal welfare certification factors.

The system 100 may include aggregating the production practice data from a plurality of producers 10, wherein the plurality of producers 10 includes one or more of a plurality of farms, ethanol production plants, coal mines, landfills, or other production sector units. Moreover, each of the plurality of producers 10 may include at least one common production practice, wherein the aggregating of production practice data includes selecting a protocol 22 for the at least one common production practice.

In many instances, producers 10 may be individually unable to produce a sufficient number of environmental emission removal units 32 to be commercial “useful”—especially in satisfaction of the environmental compliance needs of large environmental emitters 40 who desire to purchase large numbers of units on a convenient and similar basis. The aggregation of production practice data using a consistent means of collecting 24 and processing 26 data enables a number of “small” producers 10 to be effectively aggregated into a “large” producer 10, with results registered 30 and inventoried as earlier described with reference to FIG. 2, FIGS. 12A and 12B, and FIGS. 16-18. This can result in a new producer revenue stream that acts as an incentive for the individual producer 10 to achieve specific compliance conditions. By applying aggregation to a large number of producers 10, environmental compliance can be achieved by a large number of producers 10.

The system 100 includes registering 30 the effective environmental data, and converting the effective environmental data to an environmental emission removal unit 32. Registering of data 30 may include verifying the commercial suitability of the effective environmental data, recording the registering, designating the ownership of the environmental emission removal unit 32, assigning a unique identifier, which may be a protocol related identifier, may provide either temporal or spatial information regarding the production practice that caused the environmental emission removal unit 32 to be created (including geo-referenced coordinates 25), may include specific environmental emission removal unit accounting, may include full or partial encryption, and includes the case wherein a unique identifier may consist of a serial number, which may be derived relating to such parameters as those mentioned herein. The registering 30 may include monitoring transactions, wherein the transaction is one or more of environmental emission removal unit sale, transfer, exchange, and retirement.

The system 100 has the capacity to register effective environmental data with one or more Registries, individually or multiply. While individual registries may assign unique identifiers to environmental emission removal units based upon a predetermined information format, the system 100 is capable of correlating an externally assigned identifier to internal data and/or identifiers. Moreover, if/when the system 100 receives notice that an external registry has recorded a specific transaction relating to one or more environmental emissions removal unit(s) 32 created via the system 100, the system 100 has the capability to provide this transaction information, in turn, to other external registries.

In addition, the system 100 is capable of correlating all collected data relative to one or more environmental emission removal units 32. This capability makes it possible to search for one or a class of units, identifying and/or reserving them for specific use, supporting capacity planning (that is, identifying all of a certain kind of unit that are or may be available), or changing their designation as earlier described with reference to FIG. 17. These are exemplary of various data center 70 searches and functions that can be reported 35, as earlier described with reference to FIG. 2 and FIGS. 12A and 12B. This last aspect will become important if a governance jurisdiction changes a specific practice baseline through regulations, for instance, as all putative reductions/removals after a certain date will become ineligible for use. In another example, if an assessor's certifications expire, or it is discovered that a qualified assessor used an instrument lacking necessary calibration certification at time of assessment, all relevant data (and resulting environmental emission removal units 32) could be flagged as ineligible for transfer until the condition causing ineligibility is corrected.

Converting the effective environmental data to an environmental emission removal unit 32 includes converting to an “offset”, “credit”, or “allowance”, depending on restrictions imposed by the relevant environmental (emission) regime, and may include choosing a registry (or registering) jurisdiction to enable the “use” of the environmental emission removal unit 32 in a particular jurisdiction, even if other than the registration jurisdiction (e.g.: EU registration of CDM greenhouse gas project credits for sale in Japan). It may also include choosing a registry (or registering) jurisdiction to affect the designation of the environmental emission removal unit 32, such as considering it to be either a commodity, a financial instrument or a security.

Another aspect of the system 100 is to enable multi-national emitters that purchase environmental emission removal units 32 to purchase them in one governance jurisdiction and to transfer them internally to another operating division or location (situated in another governance jurisdiction) to achieve a lower overall compliance cost than might otherwise be possible. This feature also enables purchasers of environmental emission removal units 32 to aggregate their needs for such environmental emission removal units 32 in order to negotiate a lower transfer price.

The system 100 includes contracting to transfer the title of a plurality of environmental emission removal units 32 within a time period, which may include allocating at least a portion of the reserve pool 42 for mitigating transfer risk, and/or assigning title to at least a portion of the reserve pool 42 for mitigating transfer risk, and/or transferring title for at least a portion to an escrow account.

Through the process of contracting to transfer the title of a plurality of environmental emission removal units 32 within a time period, the system 100 makes it possible to enter into forward sale contracts, to meet the long term needs of buyers 40 (such as large emitters) who have to be able to reliably and cost effectively plan compliance satisfaction. Because the system 100 makes it possible to take title to a producer's data, it is possible to sever some/all producer risk from obligations incurred by contracting to transfer the title of a plurality of environmental emission removal units 32 within a time period.

The system 100 may include the selling of one or more of a plurality of environmental emission removal units 32 on standardized terms, which may include establishing a pool of environmental emission reduction units 32, wherein the pool is accessed during a point of sale event for reducing at least a portion of the environmental emissions resulting from the point of sale event or service, such as airline ticket use, purchasing fuel at the pump, or offsetting the emissions associated with the manufacture of goods or products, such as an automobile or of services, such as the generation of electricity. In another example, a pool of environmental emission reduction units 32 may be established for investment purposes, as an investment fund, or for “green bonds”, wherein the original investor realizes a pro rata return on investment profits, or realizes a return that is comprised of both cash value and offsets.

The system 100 may include allocating sub-units of environmental emission removal units 32 to one or more pools, including reserve pools, when converting data results in fractional environmental emission removal units 32.

The system 100 may include transferring the title of one or more environmental emission removal units 32 for offsetting at least a portion of the environmental emissions from an emitter, or a plurality of emitters, wherein the plurality of emitters includes a variety of emitters with either direct (e.g. manufacturers) or indirect (an individual's use of remotely generated electricity) emissions. This offsetting may be arranged or planned by an entity without regard for whether the entity produced or used the goods/services that caused the environmental emissions.

The system 100 may include the allocating of environmental emission removal units 32 from a plurality of producers 10 of a controlling entity for offsetting at least a portion of the environmental emissions of the controlling entity. This makes it possible to establish “closed loop” supply situations wherein the system 100 is used to qualify and quantify environmental emission reductions/removals 20 to offset at least a portion of the environmental emissions of a controlling entity. In this context, control may be imposed either through contract, association, or by ownership.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of processing environmental emissions, the method comprising:
selecting a producer of at least one of environmental emissions and environmental emissions removal;
comparing a production practice of the producer to pre-selected qualification criteria;
contracting with the producer regarding implementation of the production practice;
selecting a protocol sufficient for comparing the production practice to a baseline practice;
collecting production practice data regarding the producer responsive to the protocol;
warranting the production practice data by the producer;
confirming the received production practice data meets a pre-selected data standard;
converting the production practice data to environmental data using pre-selected conversion factors;
taking title to the effective environmental data by other than the producer;
modifying the environmental data to effective environmental data;
crediting the producer for at least a portion of the effective environmental data; and
registering the effective environmental data for commercial use thereof.

2. A method according to claim 1, further comprising converting the effective environmental data to an emission reduction unit for a transferring thereof.

3. A method according to claim 1, wherein the producer is selected from a producer group including at least one of agriculture, forestry, enhanced oil recovery, fuel production, semiconductor manufacturing, metal production, coal production, deep geologic sequestration, waste management, and waste landfills.

4. A method according to claim 1, wherein the producer includes a plurality of producers from a plurality of governing jurisdictions.

5. A method according to claim 1, further comprising a pre-assessing of operations data representative of the producer including at least one of collecting production, size and infrastructure data.

6. A method according to claim 1, wherein the protocol includes at least one of guidance on measurement methodologies, indirect measurement criteria, modeling, baseline definitions and measurements, IPCC Global Warming Potential (GWP) conversion factors to enable the equivalent comparison of GHG carbon dioxide equivalents (CO2e), and individual greenhouse gas performance factors.

7. A method according to claim 1, wherein the protocol includes at least one of guidance relating to environmental reductions, a government certified or approved protocol, and determines emission reduction units.

8. A method according to claim 1, wherein adhering the production practice to the protocol provides a measure of at least one of cleaner air, cleaner water, reduced erosion, electrical power generation, and enhanced land use.

9. A method according to claim 1, wherein the protocol selecting includes selecting a plurality of protocols appropriate for the producer operations

10. A method according to claim 1, wherein the production practice data collecting includes collecting available external information source data regarding the producer, and wherein the external information source data includes at least one of site physical data, cropping maps, soil maps, watershed maps, topographical maps, geographical reference data, site permit data, regulatory compliance, overhead photography, infrastructure placement, dimensional data, and commercial performance practices.

11. A method according to claim 1, wherein the warranting includes at least one of releasing legal liability for the data collecting, releasing biological security liability, and confirming the accuracy of the data collecting with respect to known production practices.

12. A method according to claim 1, wherein the production practice data collecting includes collecting on-site data regarding the producer.

13. A method according to claim 12, wherein the on-site data collecting includes at least one of collecting on-site data supplied by the producer, forming an assessment team for the on-site collecting, forming an assessment team for confirming the on-site data collecting, entering the onsite data into a pre-selected template, and electronically transmitting the production practice data to a data center.

14. A method according to claim 13, wherein the template provides for input including at least one of questions relevant to the protocol, a commercial standard, environmental compliance, non-conformance, and business needs.

15. A method according to claim 14, wherein the data entering into a template further includes recording at least one of time and geographical reference information.

16. A method according to claim 13, further comprising tracking the presence of the assessment team on the site using a GPS for enabling subsequent audit trails and reconstruction of assessment progress.

17. A method according to claim 13, wherein the template form a part of at least one of an electronic data instrument, and wherein the electronic data instrument provides for data entry and transmission thereof.

18. A method according to claim 13, further comprising modifying the template responsive to the onsite data collecting.

19. A method according to claim 18, wherein the template modifying includes documenting a non-conforming practice.

20. A method according to claim 1, wherein the production practice data collecting includes collecting commercial performance practice data including at least one of production throughput, production capacity, and animal welfare practices.

21. A method according to claim 1, further comprising:
transmitting the production practice data to a data center; and
receiving the production practice data at the data center.

22. A method according to claim 21, wherein the production practice data transmitting and receiving further includes at least one of encrypting and decrypting the production practice data, securing the data, and restricting access thereto.

23. A method according to claim 1, wherein the production practice data confirming includes measuring at least one of the integrity and completeness of the production practice data, and testing data eligibility for processing the production data.

24. A method according to claim 23, wherein data eligibility testing includes at least one of testing for non-conforming practices, reviewing contract terms for the producer, reviewing pending environmental actions for the producer, comparing production practices documented through the collection of data to the baseline practice, and 3rd party auditing of the production practice data.

25. A method according to claim 1, wherein the production practice data reporting includes at least one of comparing the production practice data to standards of performance and identifying production practice compliance through labeling.

26. A method according to claim 25, wherein the labeling includes at least one of identifying a government approval, conferring a regulatory shield, identifying the source of conditions conferring a compliance, and identifying a source of environmental removal.

27. A method according to claim 1, wherein the production practice data converting includes the production practice protocol having conversion factors selected from the group including reducing GHG emissions, providing clean water credits, providing clean air credits, providing soil erosion credits, and certifying animal welfare.

28. A method according to claim 27, wherein the GHG reducing includes a parameter selected from parameters including effluent loading, quantity animals, manure containment storage period, manure containment storage practice, number of herd turns (annual animal throughput), flaring volume, flaring efficiencies, gas types and generation rates, and chemical manufacturing efficiencies and emissions.

29. A method according to claim 1, further comprising providing guidance to the producer for enhancing the production practice responsive to the production practice data.

30. A method according to claim 29, wherein the guidance providing includes at least one of systematically balancing product output, emptying manure containment structure more frequently, and practicing a no-till for multiple contiguous years.

31. A method according to claim 1, wherein the environmental data modifying includes accounting for a data variance within +/−a predetermined percentage.

32. A method according to claim 1, further comprising at least one of allocating a first portion of the effective environmental data to a reserve pool, committing a portion of the reserve pool for mitigating delivery risk, and committing a portion of the reserve pool to mitigate permanence risk.

33. A method according to claim 32, wherein the portion of the reserve pool includes at least one of an escrow pool and a leveraged instrument pool for backing a commercial insurance policy.

34. A method according to claim 1, further comprising providing a payment to the producer for the portion of the environmental data.

35. A method according to claim 1, further comprising aggregating the production practice data from a plurality of producers.

36. A method according to claim 35, wherein the plurality of producers includes at least one common production practice.

37. A method according to claim 1, wherein the registering includes at least one of verifying a commercial suitability of the effective environmental data, recording the registering, designating ownership of the effective environmental data, assigning a unique identifier thereto, and monitoring a transaction thereof.

38. A method according to claim 37, wherein the unique identifier assigning includes at least one of a protocol related identifier, vintage, geographically referenced coordinates, specific emission reduction accounting, encryption.

39. A method according to claim 37, wherein the unique identifier is a serial number associated with a transaction.

40. A method according to claim 37, wherein the transaction monitoring includes at least one of monitoring a sale, transfer, exchange, and retirement of the environmental emission data.

41. A method according to claim 1, wherein the converting to an emission reduction unit includes at least one of using the unit for an offset, a credit, and an allowance.

42. A method according to claim 1, wherein the converting to an emission reduction unit includes choosing a registry jurisdiction.

43. A method according to claim 1, further comprising contracting to transfer the title of a plurality of emission reduction units within a time period.

44. A method according to claim 43, further comprising at least one of allocating at least a portion of a reserve pool for mitigating transfer risk, assigning title to at least a portion of a reserve pool for mitigating transfer risk, and transferring title for at least a portion to an escrow account.

45. A method according to claim 2, further comprising selling the emission reduction unit.

46. A method according to claim 45, further comprising establishing a pool for a plurality of emission reduction units and accessing the pool during a point of sale event for reducing at least a portion of the environmental emissions resulting from the point of sale event.

47. A method according to claim 46, wherein the point of sale event is selected from a group including at least one of an airline ticket, fuel at pump, coal for heating or electricity generation, and purchase of automobile.

48. A method according to claim 2, further comprising transferring title of the emission reduction unit for offsetting at least a portion of the environmental emission.

49. A method according to claim 48, wherein the environmental emission results from at least one of an emitter, a plurality of emitters, and a variety of emitters, and wherein the emitter is at least one of a direct emitter and an indirect emitter.

50. A method according to claim 2, further comprising allocating a plurality of emission reduction units from a plurality of producers of a controlling entity for offsetting environmental emissions of the controlling entity.

51. A method according to claim 1, wherein environmental emissions removal is selected from a practice group consisting of sequestration, mitigation, and avoidance.

52. A method of processing environmental emissions, the method comprising:
selecting a producer of at least one of environmental emissions and environmental emissions removal;
comparing a production practice of the producer to pre-selected qualification criteria;
selecting a protocol sufficient for comparing the production practice to a baseline practice;
collecting production practice data regarding the producer responsive to the protocol;
confirming the received production practice data meets a pre-selected data standard;
converting the production practice data to environmental data using pre-selected conversion factors; and
taking title to the environmental data by other than the producer.

53. A method according to claim 52, further comprising modifying the environmental data to effective environmental data;

54. A method according to claim 52, further comprising providing guidance to the producer for enhancing the production practice responsive to the production practice data.

55. A method according to claim 54, wherein the guidance providing includes at least one of systematically balancing product output, emptying manure containment structure more frequently, and practicing a no-till for multiple contiguous years.

56. A method according to claim 52, further comprising at least one of allocating a first portion of the effective environmental data to a reserve pool, committing a portion of the reserve pool for mitigating delivery risk, and committing a portion of the reserve pool to mitigate permanence risk.

57. A method according to claim 56, wherein the portion of the reserve pool includes at least one of an escrow pool and a leveraged instrument pool for backing a commercial insurance policy.

58. A method according to claim 52, further comprising providing a payment to the producer for at least a portion of the environmental data.

59. A method according to claim 52, further comprising establishing a pool for a plurality of emission reduction units and accessing the pool during a point of sale event for reducing at least a portion of the environmental emissions resulting from the point of sale event.

60. A method according to claim 59, wherein the point of sale event is selected from a group including at least one of an airline ticket, fuel at pump, coal for heating or electricity generation, and purchase of automobile.

61. A method according to claim 53, further comprising transferring title of the emission reduction unit for offsetting at least a portion of an environmental emission.

62. A method of processing environmental emissions, the method comprising:
selecting a production practice yielding at least one of environmental emissions and environmental emissions removal;
selecting a protocol sufficient for comparing the production practice to a baseline practice;
collecting production practice data regarding the production practice responsive to the protocol;
converting the production practice data to environmental data using pre-selected conversion factors;
registering at least a portion of the environmental data for commercial use thereof.

63. A method according to claim 62, further comprising modifying the environmental data to effective environmental data.

64. A method according to claim 62, wherein the production practice data collecting includes collecting commercial performance practice data including at least one of production throughput, production capacity, and animal welfare practices.

65. A method according to claim 62, further comprising:
transmitting the production practice data to a data center; and
receiving the production practice data at the data center.

66. A method according to claim 65, wherein the production practice data transmitting and receiving further includes at least one of encrypting and decrypting the production practice data, securing the data, and restricting access thereto.

67. A method according to claim 62, wherein the production practice data reporting includes at least one of comparing the production practice data to standards of performance and identifying production practice compliance through labeling.

68. A method according to claim 66, wherein the labeling includes at least one of identifying a government approval, conferring a regulatory shield, identifying the source of conditions conferring a compliance, and identifying a source of environmental removal.

69. A method according to claim 62, further comprising providing guidance to the producer for enhancing the production practice responsive to the production practice data.

70. A method according to claim 69, wherein the guidance providing includes at least one of systematically balancing product output, emptying manure containment structure more frequently, and practicing a no-till for multiple contiguous years.

71. A method according to claim 62, further comprising at least one of allocating a first portion of the environmental data to a reserve pool, committing a portion of the reserve pool for mitigating delivery risk, and committing a portion of the reserve pool to mitigate permanence risk.

72. A method according to claim 71, wherein the portion of the reserve pool includes at least one of an escrow pool and a leveraged instrument pool for backing a commercial insurance policy.

73. A method according to claim 62 wherein the registering includes at least one of verifying a commercial suitability of the environmental data, recording the registering, designating ownership of the environmental data, assigning a unique identifier thereto, and monitoring a transaction thereof.

74. A method according to claim 73, wherein the unique identifier assigning includes at least one of a protocol related identifier, vintage, geographically referenced coordinates, specific emission reduction accounting, encryption.

75. A method according to claim 73, wherein the unique identifier is a serial number associated with a transaction.

76. A method according to claim 73, wherein the transaction monitoring includes at least one of monitoring a sale, transfer, exchange, and retirement of the environmental emission data.

77. A method according to claim 62, further comprising converting the environmental data to a plurality of emission reduction units and choosing a registry jurisdiction for the registering thereof.

78. A method according to claim 77, further comprising selling at least a portion of the plurality of emission reduction units.

79. A method according to claim 78, further comprising establishing a pool of emission reduction units and accessing the pool during a point of sale event for reducing at least a portion of the environmental emissions resulting from the point of sale event.

80. A method according to claim 79, wherein the point of sale event is selected from a group including at least one of an airline ticket, fuel at pump, coal for heating or electricity generation, and purchase of automobile.

81. A method according to claim 77, further comprising transferring title of the emission reduction unit for offsetting at least a portion of an environmental emission.

82. A method according to claim 81, wherein the environmental emission results from at least one of an emitter, a plurality of emitters, and a variety of emitters, and wherein the emitter is at least one of a direct emitter and an indirect emitter.

83. A method according to claim 77, further comprising allocating a plurality of emission reduction units from a plurality of producers of a controlling entity for offsetting environmental emissions of the controlling entity.

84. A method of processing environmental emissions, the method comprising:
selecting a plurality of producers having production practices yielding at least one of environmental emissions and environmental emissions removal;
selecting at least one protocol sufficient for comparing each of the production practices to a baseline practice;
collecting production practice data regarding the production practices responsive to the protocol;
confirming the production practice data meets a pre-selected data standard;
converting the production practice data to environmental data using pre-selected conversion factors; and
registering the effective environmental data for commercial use thereof.

85. A method according to claim 84, further comprising modifying the environmental data to effective environmental data.

86. A method according to claim 84, wherein the collecting comprising on-site data collecting including at least one of collecting on-site data supplied by the producer, forming an assessment team for the on-site collecting, forming an assessment team for confirming the on-site data collecting, entering the onsite data into a pre-selected template, and electronically transmitting the production practice data to a data center.

87. A method according to claim 86, wherein the template provides for input including at least one of questions relevant to the protocol, a commercial standard, environmental compliance, non-conformance, and business needs.

88. A method according to claim 87, wherein the data entering into a template further includes recording time and geographical reference information.

89. A method according to claim 86, further comprising tracking a presence of the assessment team on the site using a GPS for enabling subsequent audit trails and reconstruction of assessment progress.

90. A method according to claim 86, wherein the template form a part of at least one of an electronic data instrument, and wherein the electronic data instrument provides for data entry and transmission thereof.

91. A method according to claim 86, further comprising modifying the template responsive to the onsite data collecting.

92. A method according to claim 84, further comprising providing guidance to the producer for enhancing the production practice responsive to the production practice data.

93. A method according to claim 92, wherein the guidance providing includes at least one of systematically balancing product output, emptying manure containment structure more frequently, and practicing a no-till for multiple contiguous years.

94. A method according to claim 84, further comprising at least one of allocating a first portion of the effective environmental data to a reserve pool, committing a portion of the reserve pool for mitigating delivery risk, and committing a portion of the reserve pool to mitigate permanence risk.

95. A method according to claim 94, wherein the portion of the reserve pool includes at least one of an escrow pool and a leveraged instrument pool for backing a commercial insurance policy.

96. A method according to claim 84, further comprising providing a payment to the producer for the portion of the environmental data.

97. A method according to claim 84 wherein the registering includes at least one of verifying a commercial suitability of the effective environmental data, recording the registering, designating ownership of the effective environmental data, assigning a unique identifier thereto, and monitoring a transaction thereof.

98. A method according to claim 97, wherein the unique identifier assigning includes at least one of a protocol related identifier, vintage, geographically referenced coordinates, specific emission reduction accounting, encryption.

99. A method according to claim 84 wherein the converting to an emission reduction unit includes choosing a registry jurisdiction.

100. A method according to claim 84, further comprising establishing a pool of environmental data and accessing the pool during a point of sale event for reducing at least a portion of environmental emissions resulting from the point of sale event.

101. A method according to claim 100, wherein the point of sale event is selected from a group including at least one of an airline ticket, fuel at pump, coal for heating or electricity generation, and purchase of automobile.

102. A method according to claim 84, further comprising transferring title of the environmental data for offsetting at least a portion of the environmental emissions.
